(19) United States
(12) Patent Application Publication
(10) Pub. No.: US 2021/0399973 A1
(43) Pub. Date: Dec. 23, 2021

(54) INFORMATION PROCESSING DEVICE, INFORMATION PROCESSING SYSTEM, AND CONTROL METHOD OF INFORMATION PROCESSING DEVICE

(71) Applicant: Preferred Networks, Inc., Tokyo (JP)

(72) Inventors: Daichi TERUYA, Tokyo (JP); Hiroya KANEKO, Tokyo (JP); Hirochika ASAI, Tokyo (JP)

(21) Appl. No.: 17/447,085

(22) Filed: Sep. 8, 2021

Related U.S. Application Data
(63) Continuation of application No. PCT/JP2020/009447, filed on Mar. 5, 2020.

(30) Foreign Application Priority Data
Mar. 12, 2019 (JP) 2019-044983

(51) Int. Cl. H04L 12/751; H04L 12/26

(52) U.S. Cl. CPC H04L 45/02; H04L 43/0876

(57) ABSTRACT

An information processing device includes at least one memory, and at least one processor configured to determine an information processing device that executes an instruction included in a packet, based on route information for discovering another information processing device and load information indicating a load of the another information processing device, the packet being received by the information processing device itself.

### CROSS-REFERENCE TO RELATED APPLICATIONS

This application is a continuation application of International Application No. PCT/JP2020/009447 filed on Mar. 5, 2020, and designating the U.S., which is based upon and claims priority to Japanese Patent Application No. 2019-044983, filed on Mar. 12, 2019, the entire contents of which are incorporated herein by reference.

### BACKGROUND

### 1. Technical Field

The disclosure herein relates to an information processing device, an information processing system, and a control method of the information processing device.

### 2. Description of the Related Art

In-Network Computing, in which computation is performed during the transfer of packets in a network, has attracted attention. In In-Network Computing, for example, a network is controlled so that transferred packets are processed in the order requested by the packets on nodes (processing devices) having computing functions.

Additionally, a service chaining system, in which an identification device identifies a service function to be applied to a packet, assigns an identifier (NSH: Network Service Header) to the packet, and a transferring device transfers the packet to the service function or the like by referring to the identifier, is known.

An embodiment of the present disclosure is intended to provide an information processing device that efficiently executes processing in a network.

### SUMMARY

According to one aspect of the present disclosure, an information processing device includes at least one memory, and at least one processor configured to determine an information processing device that executes an instruction included in a packet, based on route information for discovering another information processing device and load information indicating a load of the another information processing device, the packet being received by the information processing device itself.

### BRIEF DESCRIPTION OF THE DRAWINGS

FIG. 1 is a block diagram illustrating an example of an information processing system according to an embodiment of the present disclosure;

FIG. 2 is a block diagram illustrating an example of the information processing device of FIG. 1;

FIG. 3 is a diagram illustrating an example of a resource table of FIG. 2;

FIG. 4 is a diagram illustrating an example of an instruction route table of FIG. 2;

FIG. 5 is a diagram illustrating an example of a node route table of FIG. 2;

FIG. 6 is a flowchart illustrating an example of a process of an instruction determining unit of FIG. 2;

FIG. 7 is a flowchart illustrating an example of a process of a packet transferring unit of FIG. 2;

FIG. 8 is a flowchart illustrating an example of a process of a route control unit of FIG. 2;

FIG. 9 is a diagram illustrating an example of a route control packet transmitted in step S165 of FIG. 8; and

FIG. 10 is an explanatory diagram illustrating an example of the transfer of the route control packet for constructing the instruction route table.

### DETAILED DESCRIPTION

In the following, embodiments of the present disclosure will be described in detail with reference to the drawings.

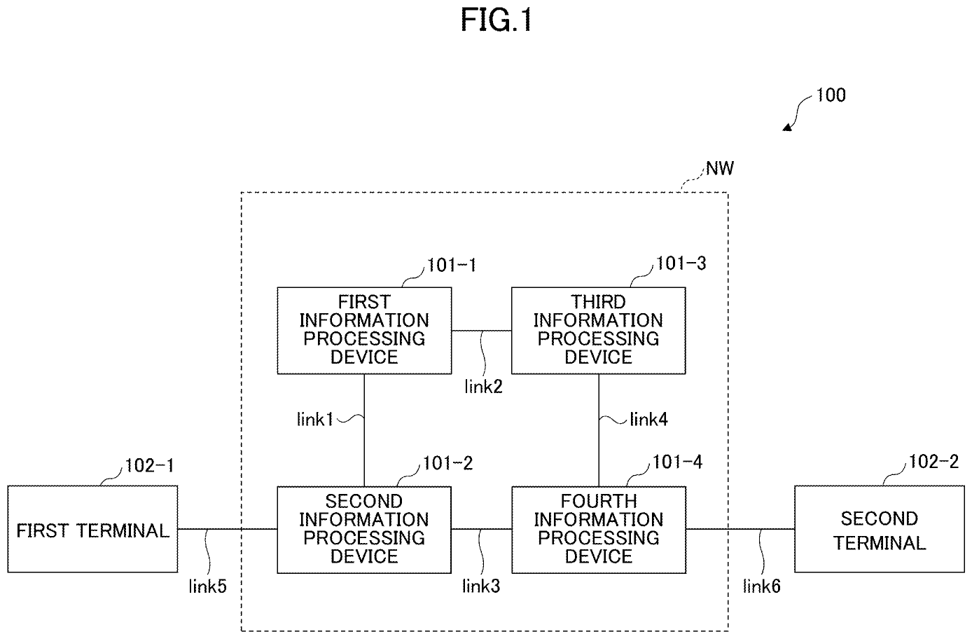

FIG. 1 is a block diagram illustrating an example of an information processing system according to an embodiment of the present disclosure. The information processing system 100 illustrated in FIG. 1 may include multiple information processing devices 101 (a first information processing device 101-1, a second information processing device 101-2, a third information processing device 101-3, and a fourth information processing device 101-4) disposed in a network NW. Here, the number of the information processing devices 101 included in the network NW is not limited to the number in FIG. 1. Hereinafter, when the first information processing device 101-1, the second information processing device 101-2, the third information processing device 101-3, and the fourth information processing device 101-4 are not distinguished for explanation, they may be referred to as information processing devices 101.

For example, at least one of the information processing devices 101 may be included in a portable terminal, such as a smartphone, or may be included in a device, such as a robot or an automobile. Additionally, at least one of the information processing devices 101 may be included in a cloud. For example, the information processing device 101 mounted in a device such as a portable terminal or a robot recognizes an object included in an image captured by a camera by using an inference method such as deep learning. At this time, it can be autonomously determined whether the inference process is performed by the information processing device 101 itself or by another information processing device 101 included in a cloud or the like in the network NW.

The information processing device 101 may be a transmitting device, or a transmitting device such as a switch may be disposed between the information processing devices 101. The network NW may be a wide area network (WAN) or may include a network other than the WAN. The size and topology of the network NW are not limited to those in FIG. 1. Hereinafter, each information processing device 101 is also referred to as a node.

The first information processing device 101-1 may be connected to the second information processing device 101-2 via a first link link1, and may be connected to the third information processing device 101-3 via a second link link2. The second information processing device 101-2 may be connected to the fourth information processing device 101-4 via a third link link3, and may be connected to a first terminal 102-1 via a fifth link link5. The fourth information processing device 101-4 may be connected to the third information processing device 101-3 via a fourth link link4, and may be connected to the second terminal 102-2 through a sixth link link6.

Hereinafter, when the first terminal 102-1 and the second terminal 102-2 are not distinguished for explanation, they may be referred to as the terminals 102. The number of the terminals 102 connected to the network NW is not limited to the number in FIG. 1. Hereinafter, when the first link link1, the second link link2, the third link link3, the fourth link link4, the fifth link link5, and the sixth link link6 are not distinguished for explanation, they may be referred to as the links.

Each information processing device 101 may have a function to transfer a packet received from another information processing device 101 or the terminal 102 and a function to execute an executable instruction included in the received packet. For example, the first terminal 102-1 or the second terminal 102-2 issues a packet including a list of instructions to be processed within the network NW. The instructions included in the packet may be sequentially executed by one or more of the information processing devices 101 in the network NW, and a result of the execution of the instruction may be transmitted to the first terminal 102-1 or the second terminal 102-2. That is, In-Network Computing may be achieved by the information processing devices 101 disposed in the network NW.

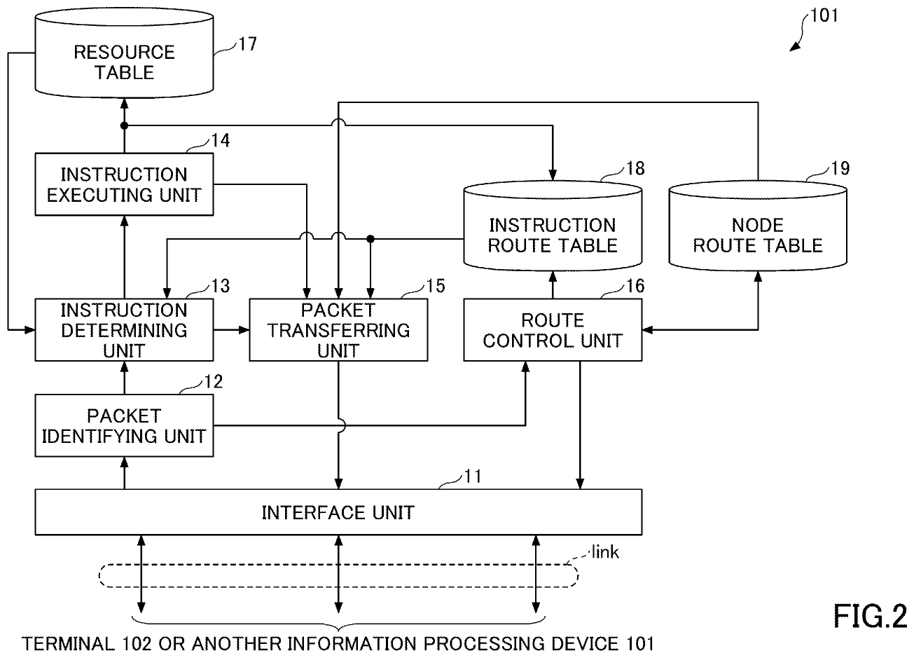

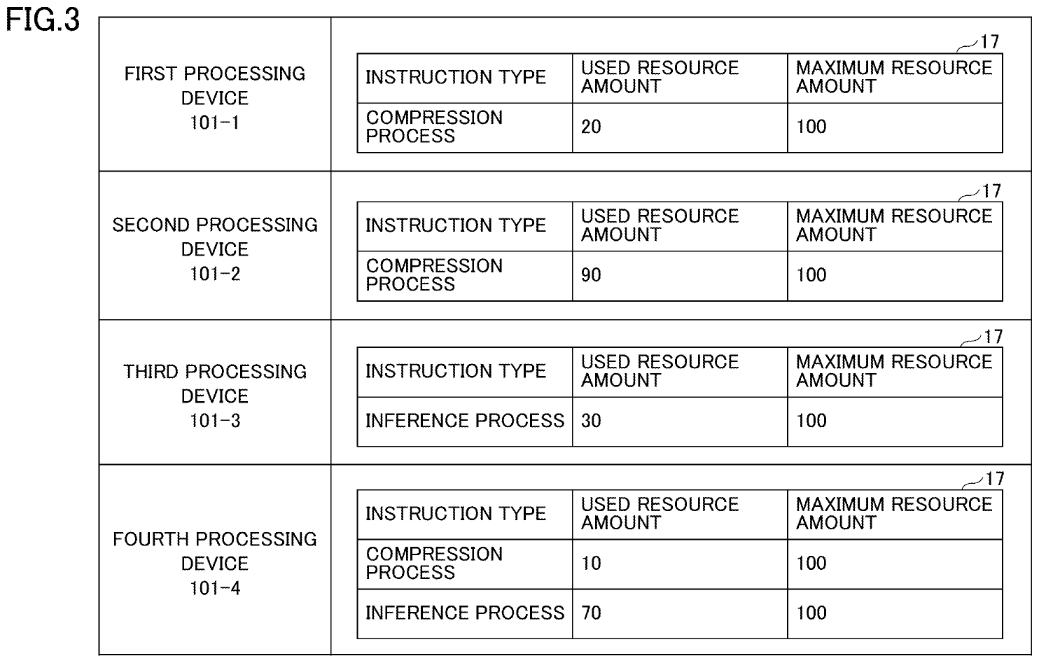

FIG. 2 is a block diagram illustrating an example of the information processing device 101 of FIG. 1. The information processing device 101 according to the present embodiment may include an interface unit 11, a packet identifying unit 12, an instruction determining unit 13, an instruction executing unit 14, a packet transferring unit 15, a route control unit 16, a resource table 17, an instruction route table 18, and a node route table 19. As described with reference to FIG. 3, in the first information processing device 101-1, the second information processing device 101-2, the third information processing device 101-3, and the fourth information processing device 101-4, the instruction executing units 14 may perform different processing (i.e., different executable instructions).

The interface unit 11, for example, transmits and receives a packet (an example of data) to and from the terminal 102 or another information processing device 101 via the link. For example, the interface unit 11 transfers the received packet to the packet identifying unit 12 and transmits the packet transferred from the packet transferring unit 15 or the route control unit 16 to the terminal 102 or another information processing device 101.

The packet identifying unit 12 may identify whether the packet transferred from the interface unit 11 includes information for controlling the information processing device 101, such as route control and alive monitoring, and, particularly in this embodiment, whether the packet is a control packet for route control. For example, the control packet for route control includes information for updating the instruction route table 18. Hereinafter, the control packet for route control is also referred to as a route control packet.

For example, a packet other than the route control packet described above is a packet including an instruction to be executed by the instruction executing unit 14 of the information processing device 101 itself or the instruction executing unit 14 of another information processing device 101, or a packet transferred to another information processing device 101. If the route control packet is detected, for example, the packet identifying unit 12 transmits the received packet to the route control unit 16, and if another packet is detected, the packet identifying unit 12 transmits the received packet to the instruction determining unit 13.

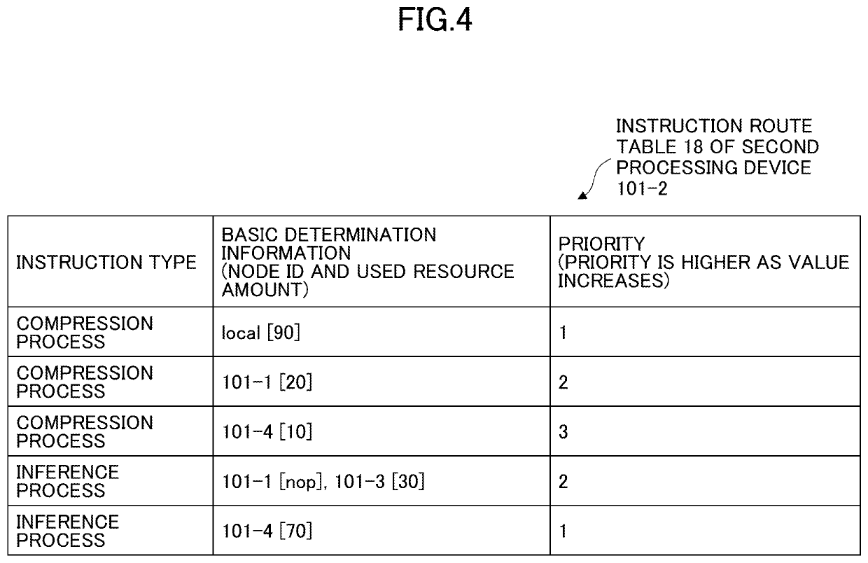

The instruction determining unit 13 may interpret the packet received from the packet identifying unit 12. For example, if no instruction is included in the packet and a destination of the packet is another information processing device 101 or the terminal 102, the instruction determining unit 13 transfers the received packet to the packet transferring unit 15. If an instruction is included in the packet received from the packet identifying unit 12, the instruction determining unit 13 refers to information stored in the instruction route table 18. The instruction determining unit 13 may determine whether the instruction determining unit 13 causes the instruction executing unit 14 of the information processing device 101 itself or the instruction executing unit 14 of another information processing device 101 to perform the instruction. Here, the instruction determining unit 13 may refer to information stored in the resource table 17 in addition to referring to the instruction route table 18. An example of the resource table 17 is illustrated in FIG. 3, and an example of the instruction route table 18 is illustrated in FIG. 4.

For example, the packet transferred to the instruction executing unit 14 includes at least one instruction, data processed by the instruction, source information of the packet, and destination information of the packet. The packet may include information indicating the execution order of the instructions if the packet includes multiple instructions.

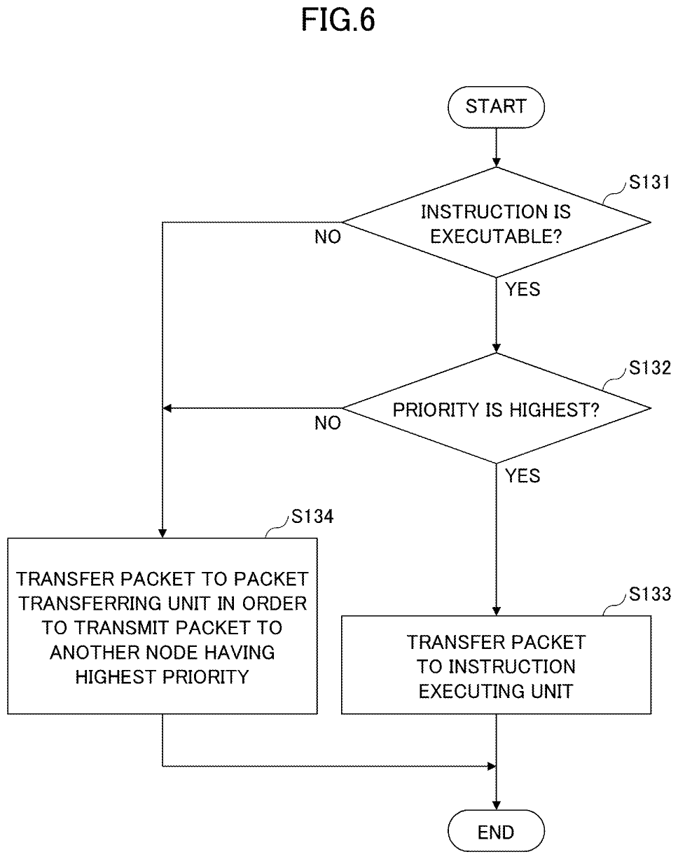

For example, if the instruction determining unit 13 causes the instruction executing unit 14 of the information processing device 101 itself to perform the instruction, the instruction determining unit 13 transfers the packet to the instruction executing unit 14. If the instruction determining unit 13 causes the instruction executing unit 14 of another information processing device 101 to perform the instruction, the instruction determining unit 13 transfers the packet to the packet transferring unit 15. An example of the process of the instruction determining unit 13 will be described in FIG. 6. The instruction determining unit 13 may determine the information processing device 101 that executes the instruction included in the received packet based on the information stored in the instruction route table 18.

The instruction executing unit 14 may execute the instruction to be executed by its own node among the instructions included in the packet received from the instruction determining unit 13. Further, the instruction executing unit 14 according to the present embodiment may update the resource table 17 and the instruction route table 18 in accordance with the amount of used resources that is changed by the execution of the instruction. The amount of used resources is described with reference to FIG. 3. The instruction executing unit 14 may transfer the packet including a result of the execution of the instruction to the packet transferring unit 15. The packet including the result of the execution of the instruction may include an instruction to be executed next and the terminal 102 as destination, to which the result of the execution is transferred.

Here, the instruction determining unit 13 may transfer the instruction and the information necessary to execute the instruction among the information included in the packet to the instruction executing unit 14. If the instruction determining unit 13 receives the result of the execution of the instruction from the instruction executing unit 14, the instruction determining unit 13 may generate a packet including the result of the execution and transfer the generated packet to the packet transferring unit 15.

The packet transferring unit 15 may determine the link to which the packet is output. For example, if the packet is received from the instruction determining unit 13, the packet transferring unit 15 refers to the node route table 19 based on the destination included in the packet, and determines the link to which the packet is output. If the packet transferring unit 15 receives the packet including the instruction to be executed next from the instruction executing unit 14, the packet transferring unit 15 refers to the instruction route table 18 and determines a node that executes the instruction. The packet transferring unit 15 may refer to the node route table 19 based on the determined node and may determine the link to which the packet including the instruction to be executed next is output. The packet transferring unit 15 transfers, to the interface unit 11, the packet together with link information indicating the determined link.

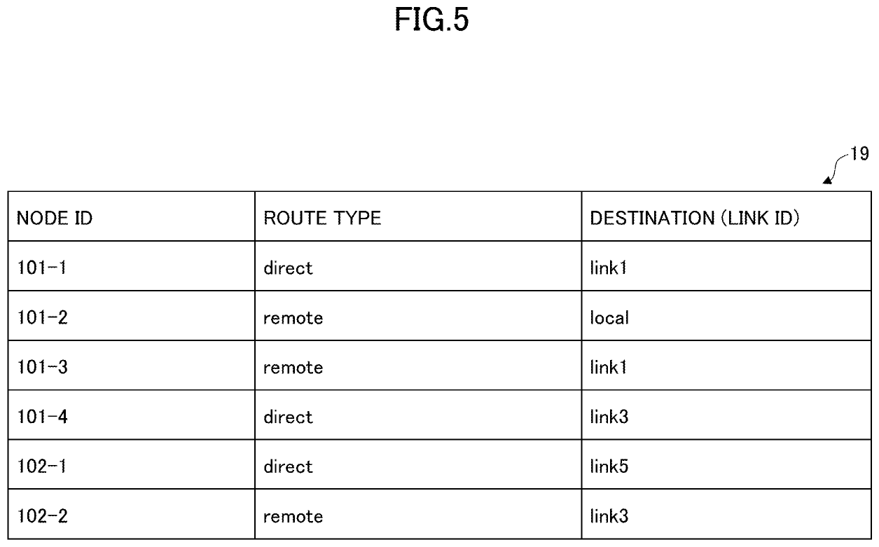

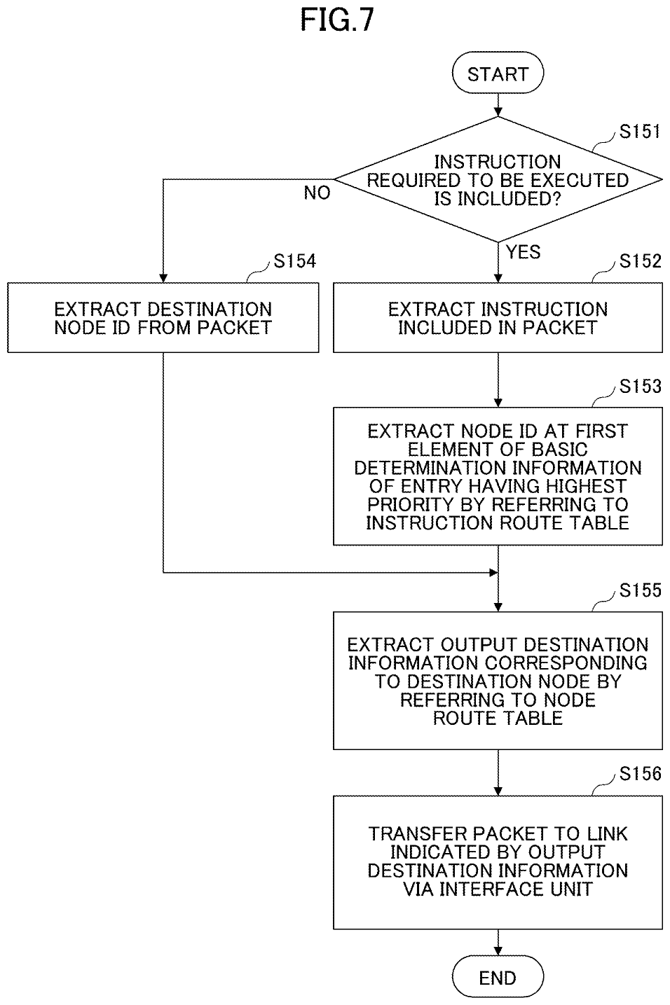

The interface unit 11 may transmit the packet to the link indicated by the link information. An example of the operation of the packet transferring unit 15 is illustrated in FIG. 7. An example of the instruction route table 18 is illustrated in FIG. 4, and an example of the node route table 19 is illustrated in FIG. 5.

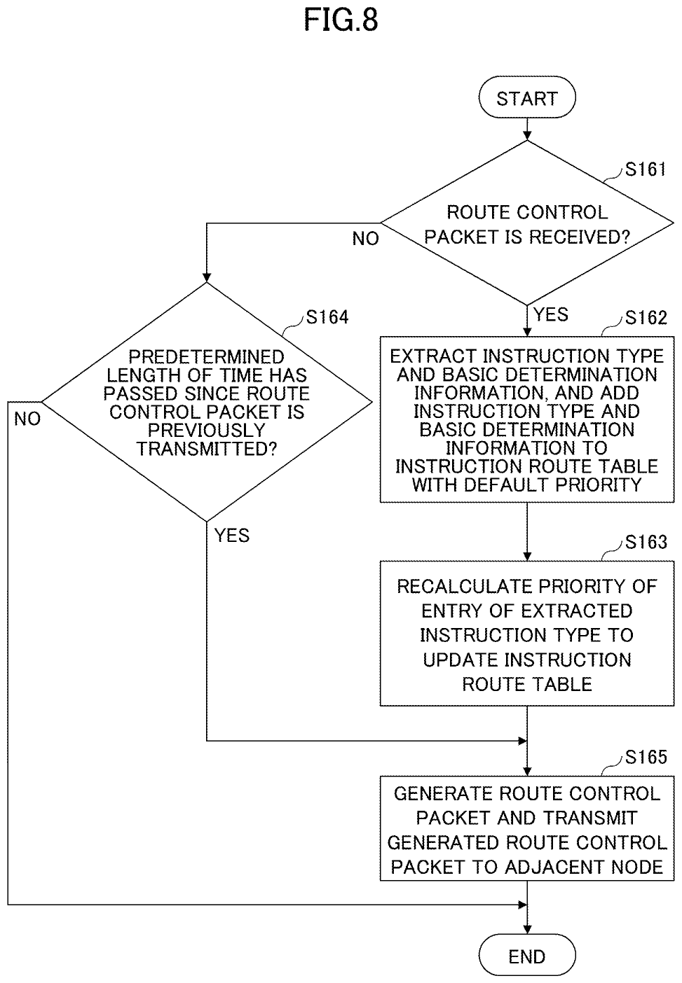

The route control unit 16, for example, updates the instruction route table 18 by using the route control packet received from the packet identifying unit 12 and resets priorities for executing the instruction based on the updated information. The route control unit 16 may transmit, to the adjacent information processing device 101 (the number of hops=“1”), the information (including the reset priorities) included in the instruction route table 18 that has been updated, via the interface unit 11. An example of the operation of the route control unit 16 is illustrated in FIG. 8.

FIG. 3 is a diagram illustrating an example of the resource table 17 of FIG. 2. The resource table 17 may be a table that stores information about the usage state of the resources of the information processing device 101. For example, the amount of currently used resources and the maximum amount of resources, which is the maximum value of the resource amount, are stored for each instruction type. The amount of used resource is an example of load information indicating the load of the information processing device 101 for each instruction type.

For example, the amount of used resources is set based on a usage rate of a processor such as a CPU mounted in the information processing device 101, a usage rate of a memory of the information processing device 101, or a usage rate of functional units (the number of used functional units) such as CPU cores that execute instructions, or the like. However, the amount of resources may be the amount of resources obtained from a combination of the usage rate of the processor, the usage rate of the memory, the usage rate of units, and the like, or may be the amount of resources obtained based on other parameters. The usage rate or the number of used units may be an average value within a predetermined time period.

For example, in the resource table 17 of the first information processing device 101-1, it can be seen that a data compression process based on a compression processing instruction can be performed, and the amount of currently used resources relative to the maximum amount of resources (=“100”) allocated to the compression process is “20”. In the resource table 17 of the fourth information processing device 101-4, it can be seen that a data compression process based on a compression processing instruction and an inference process based on an inference processing instruction can be executed. It can be seen that the amount of currently used resources relative to the maximum amount of resources allocated to the compression process (=“100”) is “10”, and the amount of currently used resources relative to the maximum resource amount allocated to the inference process (=“100”) is “70”. The type of the instruction that can be executed by the information processing system 100 is not limited to the example illustrated in FIG. 3.

FIG. 4 is a diagram illustrating an example of the instruction route table 18 of FIG. 2. The information stored in the instruction route table 18 may differ for each information processing device 101. FIG. 4 illustrates an example of the instruction route table 18 of the second information processing device 101-2. The instruction route table 18 is an example of a storage unit that stores basic determination information that includes route information for each information processing device 101 and the amount of used resources (load information) indicating a load of each information processing device 101. The determination base information is stored for each instruction type.

The instruction route table 18, for example, includes multiple entries in which the instruction type, the basic determination information, and the priority are stored for each information processing device 101 of interest that executes various instructions. The basic determination information may include a node ID of the information processing device 101 of interest, a node ID of the relay information processing device 101 disposed on a route to the information processing device 101 of interest, and load information indicating loads of the respective information processing devices 101. At least one node ID and the order of the node IDs included in the determination base information may indicate the route information for discovering the information processing device 101 of interest that can execute various instructions.

In FIG. 4, the node ID may be the same as the reference numeral of each information processing device 101, but the node ID is not limited to the above-described reference numeral as long as the information processing device 101 can be identified. For example, the node ID may be an internet protocol (IP) address, a multi-protocol label switching (MPLS) label, or the like.

Here, a node ID “local” in the determination base information may indicate a self-node (in this example, the second information processing device 101-2). “101-1”, “101-3”, and “101-4” of the determination base information may indicate the first information processing device 101-1, the third information processing device 101-3, and the fourth information processing device 101-4, respectively. A value in the brackets of the determination base information may indicate the amount of used resource, and “nop” in the brackets may indicate a node that cannot execute a corresponding instruction.

The basic determination information including one node ID may indicate that the number of hops to the transfer destination of the instruction is “1”. In FIG. 4, the number of hops for the self-node (local) may be set to “1”, but a minimum value other than “0” (for example, 0.5) may be used. With respect to this, the basic determination information including multiple node IDs separated by commas may indicate that the number of hops to the transfer destination of the instruction may be equal to the number of the node IDs included in the basic determination information. Additionally, the multiple node IDs separated by commas included in the determination base information may indicate the transfer order of the instruction, and may indicate that the instruction is transferred from the left node sequentially.

For example, a fourth entry from the top in the instruction route table 18 indicates that in order to transfer the instruction to the third information processing device 101-3 that can execute the inference process, it is necessary to pass through the first information processing device 101-1 that is a relay information processing device. The fourth entry from the top may indicate that the first information processing device 101-1 cannot perform the inference process.

A value indicating the priority of the information processing device 101 that is caused to execute the instruction for each instruction type may be stored in a priority area. In this example, as the value increases, the priority of instruction execution is set to be higher. For example, the priority of the destination of the compression processing instruction from the second information processing device 101-2 is from higher to lower in the order of the fourth information processing device 101-4, the first information processing device 101-1, and the second information processing device 101-2 (i.e., the self-node). In the example illustrated in FIG. 4, because the distances to the information processing devices 101 that execute the compression processing instruction are all one hop, including the self-node, the priority is set to be higher (the value increases) as the amount of used resource of the information processing device 101 decreases.

For example, the priority is set to be higher in the order from the smallest in a result (product) obtained by multiplying the amount of used resource of the node having the smallest resource amount and the number of hops to the node having the smallest resource amount. This can set the priority to be higher as the route length represented by the basic determination information decreases in comparison with that of another information processing device 101, and the load represented by the basic determination information may decrease in comparison with that of another information processing device 101. Note that the amount of used resource for “nop” indicating that the instruction cannot be executed is not to be multiplied.

For example, in the compression process, a multiplication result for the top entry is 90, a multiplication result for the second entry is 20, and a multiplication result for the third entry is 10. Therefore, the priority of the information processing device 101 that is the transfer destination of the compression processing instruction may be from higher to lower in the order from the smallest in the multiplication result, that is, in the order of the fourth information processing device 101-4, the first information processing device 101-1, and the second information processing device 101-2 (i.e., the self-node) as described above.

In the inference process, the multiplication result for the first entry is 60 (30×2 hops) and the multiplication result for the second entry is 70. Thus, the priority of the information processing device 101 that is a transfer destination of the inference processing instruction may become from higher to lower in the order from the smallest in the multiplication result, that is, in the order of the third information processing device 101-3 and the fourth information processing device 101-4.

As described, the priority of the execution of the instruction may be determined not only by using the route length, such as the number of hops, but also by considering the load, such as the amount of resources used by the information processing device 101, so that, for example, the instruction can be executed within the network NW while reducing the concentration of the load on a specific information processing device 101. Additionally, the instruction route table 18 according to the present embodiment may be updated by the amount of resources used by the information processing device 101 itself and the route control packet received from another information processing device 101, and the priorities are updated. Consequently, the information processing device 101 that executes the instruction included in the packet can be autonomously and dynamically determined and the instructions may be appropriately distributed and executed without external control.

Here, in the network NW illustrated in FIG. 1, the second information processing device 101-2 can transfer the inference processing instruction to the third information processing device 101-3 via the fourth information processing device 101-4. Thus, “101-4 [70], 101-3 [30]” may be stored instead of “101-1 [nop], 101-3 [30]” in the basic determination information in the fourth entry of the instruction route table 18 from the top. In this case, for example, the amount of resources used by the third information processing device 101-3 that is the minimum amount of used resources (30) is multiplied by the number of hops (2) to the third information processing device 101-3 having the minimum amount of used resources in order to determine the priority. In other words, the fourth information processing device 101-4 having the amount of used resources that exceeds the amount of resources used by the third information processing device 101-3 may be excluded from objects to be used for determining the priority.

The calculation method for determining the priority may not be limited to the method using multiplication described above. Additionally, the priority may be calculated as a numerical value of the order described above, but may be another information based on the determination base information. Additionally, the priority is not required to be stored in the instruction route table 18, and for example, the priority may be calculated based on the basic determination information retained in the instruction route table 18 every time the packet transferring unit 15 transfers the packet including the instruction.

FIG. 5 is a diagram illustrating an example of the node route table 19 of FIG. 2. The information stored in the node route table 19 may include information related to the node route and may differ for each information processing device 101. FIG. 5 illustrates an example of the node route table 19 of the second information processing device 101-2. In the following, the terminal 102 may be also treated as the information processing device and treated as one node.

The node route table 19 may include multiple entries corresponding to the respective information processing devices 101 included in the network NW and the respective terminals 102 connected to the network NW. Each entry may have an area that stores information indicating the node ID, a route type, and a destination.

In the area of the route type, for example, if a node is adjacent to the self-node (i.e., the second information processing device 101-2), information indicating “direct” is stored, and if a node is connected to the self-node via another node, information indicating “remote” is stored. In the area of the destination, a link ID identifying the link connected to the node is stored, and information indicating “local” is stored for the self-node.

The node route table 19 may be referenced if, for example, the packet transferring unit 15 and the route control unit 16 transfer the packet to another information processing device 101 or the terminal 102. For example, if the configuration of the network NW is determined, the node route table 19 is generated regardless of whether the information processing device 101 is used to execute an instruction. The node ID may be other identification information, such as an IP address or an MPLS label, as long as the information processing device 101 can be identified. Identification information indicating a next hop may be used as the destination, instead of the identification information indicating the link.

FIG. 6 is a flowchart illustrating an example of a process of the instruction determining unit 13 of FIG. 2. That is, FIG. 6 illustrates an example of a control method of the information processing device 101. The process illustrated in FIG. 6 may start in response to receiving the packet including the instruction from the packet identifying unit 12.

First, in step S131, the instruction determining unit 13 may refer to the resource table 17 to determine whether the instruction included in the packet received from the packet identifying unit 12 can be executed by the instruction executing unit 14. Specifically, the instruction determining unit 13 may determine whether the type of instruction included in the packet received from the packet identifying unit 12 matches any of the instruction types stored in the resource table 17. If the instruction types match, the process proceeds to step S132. If the instruction types do not match, the process proceeds to step S134.

In step S132, the instruction determining unit 13 may refer to the instruction route table 18 to determine whether the priority of the self-node that corresponds to the executable instruction determined in step S131 is the highest. If the priority is the highest, the process proceeds to step S133, and if the priority of another node is higher than the priority of the self-node, the process proceeds to step S134.

In step S133, because it is optimal that the self-node executes the instruction, the instruction determining unit 13 may transfer the packet including the instruction to the instruction executing unit 14 and may end the process. With respect to the above, in step S134, in order to transfer the instruction to another node having the highest priority, the instruction determining unit 13 may transfer the packet including the instruction to the packet transferring unit 15 and ends the process.

Here, in step S132, the instruction determining unit 13 may determine that the instruction executing unit 14 of the self-node executes the instruction based on the amount of resources used by the self-node rather than the determination based on the priority. For example, if the amount of used resources is less than or equal to a predetermined threshold value, the instruction determining unit 13 may determine that the execution of the self-node is appropriate and the process may proceed to step S133. Additionally, based on the trend of the amount of resources used in the past, the amount of used resources when the instruction is executed may be predicted, and if a result of the prediction is below a predetermined threshold value, the process may proceed to step S133. Further, if the number of hops to the terminal 102 that is a destination is small and the information processing device 101 that executes the instruction is limited, even if the amount of used resources exceeds the predetermined threshold value, it may be determined that there is room for the resources and that the execution of the self-node is appropriate, and the process may progress to step S133.

FIG. 7 is a flowchart illustrating an example of a process of the packet transferring unit 15 of FIG. 2. That is, FIG. 7 illustrates an example of a control method of the information processing device 101. The process illustrated in FIG. 7 may start in response to receiving the packet from the instruction determining unit 13 or the instruction executing unit 14.

First, in step S151, the packet transferring unit 15 may determine whether the instruction required to be executed is included in the received packet. If the instruction required to be executed is included, the process proceeds to step S152, and if no instruction required to be executed is included, the process proceeds to step S154.

In step S152, the packet transferring unit 15 may extract the instruction included in the packet. Next, in step S153, the packet transferring unit 15 may refer to the instruction route table 18 to extract a node ID of the first element in the basic determination information of the entry having the highest priority among the entries corresponding to the instruction type extracted in step S152. The extracted node ID of the first element may indicate an adjacent node and is used as a destination node for the packet. After step S153, the process may proceed to step S155.

With respect to the above, in step S154, the packet transferring unit 15 may extract the ID of the destination node from the packet and proceeds to step S155.

In step S155, the packet transferring unit 15 may refer to the node route table 19 to extract the destination information (the link ID) corresponding to the destination node. Next, in step S156, the packet transferring unit 15 may transfer the packet to the link indicated by the destination information extracted in step S155 via the interface unit 11 and ends the process.

FIG. 8 is a flowchart illustrating an example of a process of the route control unit 16 of FIG. 2. That is, FIG. 8 illustrates an example of a control method of the information processing device 101. Preferably, the process illustrated in FIG. 8 may be repeated at a predetermined period.

First, in step S161, the route control unit 16 may determine whether the route control packet is received. If the route control packet is received, the process proceeds to step S162. If the route control packet is not received, the process proceeds to step S164.

In step S162, the route control unit 16 may extract the instruction type and the determination base information from the route control packet and may add the extracted instruction type, the extracted determination base information, and a default priority to the instruction route table 18. The default priority may be set to “0” indicating an invalid value.

Next, in step S163, the route control unit 16 may recalculate the priorities based on a predetermined calculation equation for entries that retain the same instruction type as the instruction type added in step S162 to update the instruction route table 18. For example, the route control unit 16 may determine the priority in accordance with the route length (for example, the number of hops) to the transfer destination of the instruction indicated by the basic determination information and the amount of resources of the information processing device 101 that is a transfer destination of the instruction for each instruction type. The route control unit 16 may select an entry having the highest priority for each instruction type.

As an example, as illustrated in FIG. 4, the priority is set to be higher (the value increases) for each instruction type, as a value obtained by multiplying the number of hops to the information processing device 101 having the smallest amount of used resources by the amount of used resources decreases. Then, the instruction route table 18 may be updated based on the added entries and the recalculated priorities based on the added entries. Here, when the priorities are updated, a predetermined number of entries may be deleted from the instruction route table 18 in order from the lowest priority for each instruction type.

With respect to the above, in step S164, the route control unit 16 may determine whether a predetermined length of time has elapsed since the previous transmission of the route control packet. If the predetermined length of time has elapsed, the process proceeds to step S165, and if the predetermined length of time has not elapsed, the process ends.

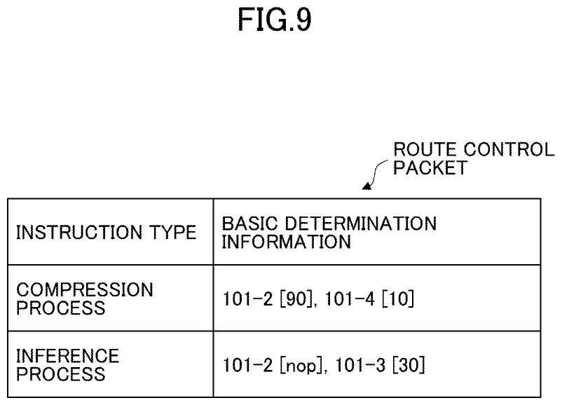

In step S165, the route control unit 16 may generate the route control packet in which the node ID and the amount of used resources of the self-node are added to the basic determination information of the entry having the highest priority selected for each instruction type in the instruction route table 18. Here, the node ID and the amount of used resources of the self-node may be added to the beginning of the determination base information. An example of the route control packet is illustrated in FIG. 9.

For example, the amount of resources used by the self-node is extracted from the resource table 17. The route control unit 16 may transmit the generated route control packet to the information processing device 101 adjacent to the self-node (the number of hops=“1”), and the process ends. Here, the route control unit 16 may generate a route control packet in which the node ID and the amount of used resources of the self-node are added to the basic determination information of two or more entries in order from the highest priority for each instruction type.

In the process of step S165 based on the passage of the predetermined length of time in step S164, if the changed amount of resources used by the self-node is less than or equal to a predetermined threshold value (for example, the changed amount is 10% or less), the transmission of the route control packet may be suspended. This can reduce the transmission frequency of the route control packet, and can reduce the communication load of the network NW.

The route control unit 16 of the adjacent information processing device 101 that has received the route control packet may perform the processing of step S161, step S162, and step S163 of FIG. 8, and may perform the update on the instruction route table 18. Additionally, the route control unit 16 may perform the processing of step S165 of FIG. 8 and may transfer, to the adjacent node, the basic determination information indicating the information processing device 101 having the highest priority after the update together with the basic determination information about the self-node.

Consequently, the update of the instruction route table 18 may be performed sequentially in the information processing device 101 included in the network NW illustrated in FIG. 1. As described, according to the present embodiment, the type of the instruction that can be executed by the self-node and the amount of used resources can be autonomously exchanged with each other among the information processing devices 101 in a distributed manner. This can dynamically update the optimum transfer route for the packet and the usage state of the calculation resources, and appropriately select the information processing device 101 suitable to perform the processing.

The route control unit 16 may transfer an alive check packet that checks that another information processing device 101 is alive at a predetermined frequency. The information about the information processing device 101 that cannot be checked to be alive may be deleted from the instruction route table 18.

Further, if the information processing device 101 that is not registered in the instruction route table 18 has become able to execute at least one of the instructions indicated by the instruction types, the route control unit 16 of the information processing device 101 may transfer the route control packet for a new registration to the adjacent node. This may register the information of the information processing device 101 that has become able to execute the instruction in the instruction route table 18, and enables the information processing device 101 that has become to be able to execute the instruction to execute the instruction.

If the information processing device 101 registered in the instruction route table 18 has become unable to execute the instruction registered in the instruction route table 18, the route control packet for deletion of the registration may be transferred to the adjacent node. This can update the instruction route table 18 of another information processing device 101, and a failure in which the packet is not successfully transferred by using the instruction route table 18 that is incorrect can be prevented.

The route control unit 16 of the information processing device 101 that receives the route control packet from another information processing device 101 that has become to be able to execute the instruction or another information processing device 101 that has become unable to execute the instruction may add or delete an entry. After adding or deleting an entry, the route control unit 16 may update the basic determination information of the instruction route table 18, then recalculate the priorities for each instruction type, and store new priorities obtained by the recalculation in the instruction route table 18.

FIG. 9 illustrates an example of the route control packet transmitted by the second information processing device 101-2. The route control packet illustrated in FIG. 9 is an example of the route control packet transmitted by the route control unit 16 of the second information processing device 101-2 when it is determined in step S164 of FIG. 8 that a predetermined length of time has elapsed.

The route control packet includes an area that stores the basic determination information for each instruction type, for example. The meaning of the instruction type and the determination base information included in the route control packet may be substantially the same as the information stored in the instruction route table 18 illustrated in FIG. 4. However, the node ID and the amount of used resources of the self-node that issues the route control packet may be stored at the beginning of the basic determination information included in the route control packet. At the second element of the basic determination information included in the route control packet, the node ID and the amount of used resources of the entry having the highest priority in the instruction route table 18 may be stored.

In the instruction route table 18 illustrated in FIG. 4, in the compression process, the priority of the fourth information processing device 101-4 is the highest, and in the inference process, the priority of the third information processing device 101-3 is the highest. Thus, in the entry of the compression process in the route control packet, the basic determination information (101-4 [10]) of the fourth information processing device 101-4 may be stored, following the basic determination information (101-2 [90]) of the self-node. In the entry of the inference process in the route control packet, the basic determination information (101-3 [30]) of the third information processing device 101-3 may be stored, following the basic determination information (101-2 [nop]) of the self-node. Here, because the second information processing device 101-2 cannot perform the inference process, the amount of used resources for the basic determination information of the second information processing device 101-2 may be set to “nop”.

As described above, the route control unit 16 may generate a route control packet in which the node ID and the amount of used resources of the self-node are added to the basic determination information of two or more entries in the order from the highest priority in the instruction route table 18 for each instruction type. For example, if the basic determination information of two entries in the order from the highest priority is included in the route control packet, in the compression process, the basic determination information (101-1 [20]) is added after the basic determination information (101-4 [10]). In the inference process, the determination base information (101-4 [70]) may be added after the determination base information (101-3 [30]).

By including the basic determination information of two or more entries in the route control packet in the order from the highest priority and transmitting the route control packet, the accuracy of the process of calculating the priority according to step S163 of FIG. 8 can be improved, and the effective performance of the instruction executed by the information processing system 100 can be improved.

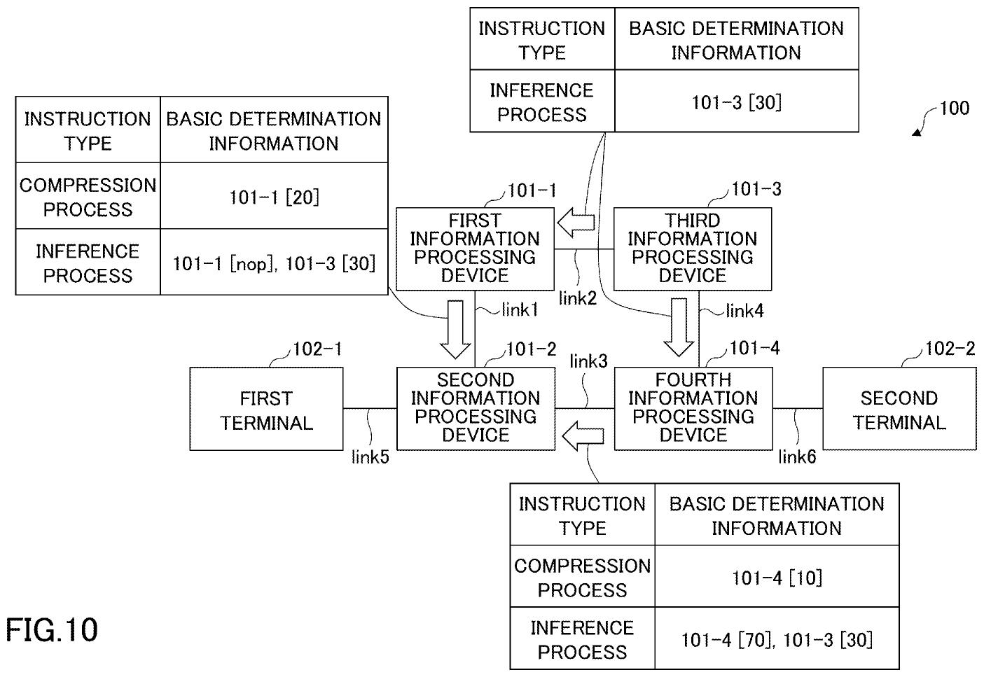

FIG. 10 is an explanatory diagram illustrating an example of transferring the route control packet for constructing the instruction route table 18. FIG. 10 illustrates an example of constructing the instruction route table 18 (FIG. 4) of the second information processing device 101-2.

In Step S164 of FIG. 8, for example, the third information processing device 101-3 determines that the predetermined length of time has elapsed, and thus transmits the route control packet including the basic determination information (101-3 [30]) to the adjacent node. Here, because the route control unit 16 of the third information processing device 101-3 has the highest priority for the self-node, the route control unit 16 transmits the route control packet including only the determination base information including the self-node to the first information processing device 101-1 and the fourth information processing device 101-4, which are adjacent nodes. In this example, the instruction route table 18 of the third information processing device 101-3, which cannot perform the compression process, does not store the basic determination information corresponding to the compression process. Therefore, the basic determination information corresponding to the compression process is not included in the route control packet.

The first information processing device 101-1 that receives the route control packet from the third information processing device 101-3 may generate the route control packet including the basic determination information about the self-node and the basic determination information about the node having the highest priority for each instruction type. If the priority of the self-node is the highest for each instruction type, only the basic determination information about the self-node is included in the route control packet. The method of generating the route control packet may be substantially the same as the method described in step S165 of FIG. 8 and the method described with reference to FIG. 9. The first information processing device 101-1 may transmit the generated route control packet to the second information processing device 101-2.

As with the first information processing device 101-1, the fourth information processing device 101-4 that receives the route control packet from the third information processing device 101-3 also may generate the route control packet including the basic determination information about the self-node and the basic determination information about the node having the highest priority for each instruction type. The fourth information processing device 101-4 may transmit the generated route control packet to the second information processing device 101-2.

The route control unit 16 of the second information processing device 101-2 may update the instruction route table 18, recalculate the priorities, and store the recalculated priorities in the instruction route table 18 every time the route control packet is received from the adjacent node. Then, the instruction route table 18 illustrated in FIG. 4 may be generated.

As described above, according to the present embodiment, the information processing device 101 that executes the instruction included in the packet may be determined based on the priority obtained from the number of hops and the amount of used resources, rather than simply depending on the number of hops. In other words, the transfer destination of the packet including the instruction may be determined based on the priority obtained from the route length and the load on the node.

This can autonomously and dynamically determine the information processing device 101 that executes the instruction included in the packet by considering the route length to each information processing device 101 and the load on each information processing device 101. For example, the service chaining in which multiple services are connected to each other and executed as a single service can be executed autonomously by each information processing device 101 without external control.

Additionally, in order to update the instruction route table 18 at a predetermined frequency to recalculate the priority and determine the information processing device 101 that executes the instruction, the load can be dynamically distributed in accordance with the margin of the processing capacity of each information processing device 101. The concentration of the load toward a specific information processing device 101 can be prevented, thereby suppressing the degradation of the processing performance of the information processing system 100.

Additionally, the autonomous packet transfer control and the execution control of the instruction can be performed, so that it is not necessary to provide the control device connected to the network NW for controlling the information processing device 101 in a concentrated manner. Even when a new information processing device 101 has become to be able to execute the instruction, the route control packet can be transmitted, the instruction route table 18 of each information processing device 101 can be updated, and the priority can be recalculated, so that the new information processing device 101 can be controlled. As a result, the size limitation of the information processing system 100 that is problematic when controlled by the above-described control device can be eliminated, and the scalable information processing system 100 can be constructed.

The information of the information processing device 101 that cannot be determined to be alive with the alive check packet can be deleted from the instruction route table 18. Therefore, even when the information processing device 101 or the link is down, the information processing device 101 determined based on the priority retained in the instruction route table 18 is caused to execute the instruction. As a result, the fault resistance of the information processing system 100 can be improved.

Further, any of the information processing devices 101 is mounted to a device such as a portable terminal or a robot to perform processing such as deep learning. In this case, it can be determined whether the processing is performed by oneself (e.g., the portable terminal or the robot) or whether the processing is left to the cloud or the switch included in the network NW. At this time, each information processing device 101 may update the basic determination information every time the route control packet is received from the adjacent node to update the priority of the execution of the instruction. Thus, each information processing device 101 can determine autonomously and dynamically who should execute the processing without grasping the overall state of the network NW.

The present disclosure is not limited to the above specifically disclosed embodiments, and various modifications and variations can be made without departing from the scope of the claims.

What is claimed is:

1. An information processing device comprising:
at least one memory; and
at least one processor configured to:
determine an information processing device that executes an instruction included in a packet, based on route information for discovering another information processing device and load information indicating a load of the another information processing device, the packet being received by the information processing device itself.

2. The information processing device as claimed in claim 1, wherein the packet is transferred to a destination device via a network and the packet includes one or more instructions to be executed by one or more information processing devices in the network in a course of the packet being transferred in the network, the network including the information processing device itself and the another information processing device.

3. The information processing device as claimed in claim 2, wherein, in a case where the packet includes a plurality of instructions to be sequentially executed in a predetermined order in the course of the packet being transferred in the network, the packet is transferred to the destination device, the packet including a result of executing the plurality of instructions sequentially in the predetermined order in the course of the packet being transferred in the network.

4. The information processing device as claimed in claim 1,
wherein a network including the information processing device includes a plurality of information processing devices, each of the plurality of information processing devices being the another information processing device and configured to execute the instruction included in the received packet,
wherein the route information and the load information are stored for each of the plurality of information processing devices, and
wherein the at least one processor determines the information processing device that executes the instruction among the plurality of information processing devices based on the route information and the load information stored for each of the plurality of information processing devices that can execute the instruction included in the received packet.

5. The information processing device as claimed in claim 1, wherein the at least one processor is further configured to transfer, upon determining that the instruction included in the packet is to be executed by the another information processing device, the packet to the another information processing device.

6. The information processing device as claimed in claim 1,
wherein the load information includes load information indicating a load of the information processing device itself, and
wherein the at least one processor executes the instruction upon determining that the instruction is to be executed by the information processing device itself.

7. The information processing device as claimed in claim 1, wherein the route information and the load information can be updated through a communication with the another information processing device.

8. The information processing device as claimed in claim 7,
wherein the at least one processor determines priorities based on the route information and the load information, the priorities being different for each of the information processing device itself and the another information processing device, and determines the information processing device that executes the instruction by using the determined priorities, and
wherein the at least one processor is further configured to update the route information and the load information based on the route information and the load information included in a control packet, and update the priorities based on the updated route information and the updated load information, the control packet being received from the another information processing device.

9. The information processing device as claimed in claim 8,
wherein a network including the information processing device includes a plurality of information processing devices, each of the plurality of information processing devices being the another information processing device and configured to execute the instruction included in the received packet, and
wherein the at least one processor set a priority of a given information processing device among the information processing device itself and the plurality of information processing devices to be higher as a route length indicated by the route information of the given processing device and a load indicated by the load information of the given processing device become smaller, comparing with information processing devices that are other than the given processing device.

10. The information processing device as claimed in claim 9,
wherein the route information and the load information for a given information processing device among the plurality of information processing devices and the route information and the load information for a relay information processing device disposed on a route to the given information processing device are stored for each of the plurality of information processing devices, and
wherein the at least one processor selects an information processing device having a smallest load indicated by the load information stored for each of the plurality of information processing devices, calculates a multiplication value obtained by multiplying the load of the selected information processing device by the route length to the selected information processing device, and set the priorities higher in order from a smallest value of the multiplication value.

11. The information processing device as claimed in claim 1, wherein the route information and the load information are stored for the instruction included in the packet, and another route information and another load information that are different from the route information and the load information are stored for a predetermined instruction that is different from the instruction.

12. A information processing method comprising:
determining an information processing device that executes an instruction included in a packet, based on route information for discovering another information processing device and load information indicating a load of the another information processing device, the packet being received by the information processing device itself.

13. The information processing method as claimed in claim 12, wherein the packet is transferred to a destination device via a network and the packet includes one or more instructions to be executed by one or more information processing devices in the network in a course of the packet being transferred in the network, the network including the information processing device itself and the another information processing device.

14. The information processing method as claimed in claim 13, wherein, in a case where the packet includes a plurality of instructions to be sequentially executed in a predetermined order in the course of the packet being transferred in the network, the packet is transferred to the destination device, the packet including a result of executing the plurality of instructions sequentially in the predetermined order in the course of the packet being transferred in the network.

15. The information processing method as claimed in claim 12,
wherein a network including the information processing device includes a plurality of information processing devices, each of the plurality of information processing devices being the another information processing device and configured to execute the instruction included in the received packet,
wherein the route information and the load information are stored for each of the plurality of information processing devices, and
wherein the information processing method further comprises determining the information processing device that executes the instruction among the plurality of information processing devices based on the route information and the load information stored for each of the plurality of information processing devices that can execute the instruction included in the received packet.

16. The information processing method as claimed in claim 12, further comprising:
transferring, upon determining that the instruction included in the packet is to be executed by the another information processing device, the packet to the another information processing device.

17. The information processing method as claimed in claim 12,
wherein the load information includes load information indicating a load of the information processing device itself, and
wherein the information processing method further comprises executing the instruction upon determining that the instruction is to be executed by the information processing device itself.

18. The information processing method as claimed in claim 12, wherein the route information and the load information can be updated through a communication with the another information processing device.

19. The information processing method as claimed in claim 18, further comprising:
determining priorities based on the route information and the load information, the priorities being different for each of the information processing device itself and the another information processing device, and determines the information processing device that executes the instruction by using the determined priorities, and
updating the route information and the load information based on the route information and the load information included in a control packet, and update the priorities based on the updated route information and the updated load information, the control packet being received from the another information processing device.

20. The information processing method as claimed in claim 19,
wherein a network including the information processing device includes a plurality of information processing devices, each of the plurality of information processing devices being the another information processing device and configured to execute the instruction included in the received packet, and
wherein the information processing method further comprises setting a priority of a given information processing device among the information processing device itself and the plurality of information processing devices to be higher as a route length indicated by the route information of the given processing device and a load indicated by the load information of the given processing device become smaller, comparing with information processing devices that are other than the given processing device.
